(19) United States
(12) Patent Application Publication
(10) Pub. No.: US 2017/0118761 A1
(43) Pub. Date: Apr. 27, 2017

(54) Managing a Radio Frequency Resource Chain In a Multi-Subscription Multi-Standby Communication Device For Cell Acquisition

(71) Applicant: QUALCOMM Incorporated, San Diego, CA (US)

(72) Inventor: Yogesh Deshpande, Ashford (GB)

(21) Appl. No.: 14/962,589

(22) Filed: Dec. 8, 2015

Related U.S. Application Data
(60) Provisional application No. 62/245,437, filed on Oct. 23, 2015.

(51) Int. Cl. H04W 72/04; H04W 72/06

(52) U.S. Cl. CPC H04W 72/0493; H04W 72/06; H04W 88/06

(57) ABSTRACT

Examples include systems and methods for managing a radio frequency (RF) resource in a multi-subscription multi-standby communication device during cell acquisition. A first radio resource management sublayer associated with a first radio access technology may receive a request to establish a high priority communication session over a communication network using a first subscription. The multi-subscription multi-standby communication device may initialize a guard timer for a guard time period in response to receiving the request to establish the communication session over the communication network. The multi-subscription multi-standby communication device may block access to the RF resource by a second subscription of the MSMS communication device until the guard time period has elapsed, or until the high priority communication session has been established on the first subscription.

### RELATED APPLICATIONS

This application claims the benefit of priority to U.S. Provisional Application No. 62/245,437 entitled “Managing a Radio Frequency Resource Chain In a Multi-Subscription Multi-Standby Communication Device For Cell Acquisition” filed Oct. 23, 2015, the entire contents of which are hereby incorporated by reference.

### BACKGROUND

Wireless devices having multiple subscriber identity modules (SIMs) may communicate with two or more cells of a wireless network. Some multi-subscription multi-standby communication devices may allow two or more network interfaces or subscriber identity modules (SIMs) to share a single radio frequency (RF) resource chain (e.g., dual-SIM dual-standby, or “DSDS” devices). However, the RF resource chain in such devices can only tune to a single network at a time. The multi-subscription multi-standby communication device may employ a “tune-away” procedure to monitor multiple interfaces in a standby mode by tuning to one network in a primary cell, quickly tuning away to the second network in a second cell for a short time, and then tuning back to the first network to continue a voice or data call. This tune-away procedure may allow the multi-subscription multi-standby communication device to monitor for pages or other indications of incoming messages or data received on the second network, to receive signals from other cells for cell selection or reselection, and to monitor signals other than bearer or control signals (e.g., master information blocks (MIBs) and system information blocks (SIBs)), from two or more communication networks.

Tuning away from a first network to a second network may interrupt communications with the first network, and may reduce the speed and efficiency with which the multi-subscription multi-standby communication device may conduct communication activities with the first network. For example, during a process of cell selection or cell acquisition on the first network for intended service of a device-originated voice communication session (e.g., a voice call or an Emergency call), performing tune-aways to the second network may frequently interrupt the cell selection/acquisition activities on the first network, causing substantial delay in completing the cell selection or acquisition activities, in addition to delaying any pending communication session on the first network (like Normal voice call origination or Emergency call origination).

### SUMMARY

Various examples include methods and multi-subscription multi-standby communication devices implementing methods for managing access to an RF resource for performing cell acquisition activities on a first subscription, to mitigate interruptions of a cell selection or cell acquisition procedure for the establishment of a high priority service such as a device-originated voice communication session that may be caused by network/communication activity on a second subscription (e.g., tune-aways to a second subscription). Various examples may include receiving at a first radio resource management sublayer associated with a first radio access technology a request to establish a communication session over a communication network using a first subscription, initializing a guard timer for a guard time period, and blocking access to the RF resource by a second subscription of the multi-subscription multi-standby communication device until the guard time period has elapsed.

In some examples, receiving at the first radio resource management sublayer associated with the first radio access technology the request to establish the voice communication session over the communication network may include receiving the request to establish the voice communication session over the communication network from a second radio resource management sublayer associated with a second radio access technology. In some examples, the method may further include receiving, at the second radio resource management sublayer associated with the second radio access technology, a communication session rejection message from the communication network.

In some examples, receiving, at the first radio resource management sublayer associated with the first radio access technology, the request to establish the voice communication session over the communication network may include receiving the request to establish the voice communication session over the communication network from a non-access stratum of the MSMS communication device. In some examples, the requested voice communication session over the communication network may be assigned a relatively higher priority over a non-voice communication of the second subscription. Some examples may further include performing a cell acquisition procedure on the first subscription during the guard time period. Such examples may further include determining whether the cell acquisition procedure on the first subscription has been completed, establishing the voice communication session over the communication network using the first subscription in response to determining that the cell acquisition procedure has been completed, and permitting access to the RF resource by the second subscription.

Some examples may further include determining whether the guard time period has elapsed, and permitting access to the RF resource by the second subscription in response to determining that the guard time period has elapsed. Some examples may further include determining whether a cell acquisition failure is detected, and permitting access to the RF resource by the second subscription in response to determining that the cell acquisition failure is detected.

Some examples may further include continuing performance of the cell acquisition procedure in response to determining that the cell acquisition failure is not detected. Some examples may further include detecting that the voice communication session over the communication network is completed, and permitting access to the RF resource by the second subscription.

Further examples may include a multi-subscription multi-standby communication device having a processor configured to perform operations of the methods described above. Further examples may include a multi-subscription multi-standby communication device having means for performing functions of the methods described above. Further examples include a non-transitory processor-readable storage medium on which is stored processor-executable instructions configured to cause a processor of a multi-subscription multi-standby communication device to perform operations of the methods described above.

### BRIEF DESCRIPTION OF THE DRAWINGS

The accompanying drawings, which are incorporated herein and constitute part of this specification, illustrate examples. Together with the general description given above and the detailed description given below, the drawings serve to explain features of the various examples, and not to limit the claims.

FIG. 1 is a component block diagram of an example communication system.

FIG. 2 is a component block diagram of an example multi-subscription multi-standby communication device.

FIG. 3 is a system architecture diagram illustrating example protocol layer stacks implemented by the wireless communication device of FIG. 2.

FIG. 4 is a message flow diagram illustrating an example method for managing an RF resource in a multi-subscription multi-standby communication device for cell acquisition.

FIG. 5 is a message flow diagram illustrating an example method for managing an RF resource in a multi-subscription multi-standby communication device for cell acquisition.

FIG. 6 is a process flow diagram illustrating an example method for managing an RF resource in a multi-subscription multi-standby communication device for cell acquisition.

FIG. 7 is a message flow diagram illustrating an example method for managing an RF resource in a multi-subscription multi-standby communication device for cell acquisition.

FIG. 8 is a process flow diagram illustrating an example method for managing an RF resource in a multi-subscription multi-standby communication device for cell acquisition.

FIG. 9 is a component block diagram of a mobile communication device suitable for use with various embodiments.

### DETAILED DESCRIPTION

Various examples will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various examples include methods implemented in multi-subscription multi-standby communication devices that enable managing the performance of a small cell search function to receive signals from one or more small cells in a manner that reduces the impact of the search function on an active communication session.

The term “multi-subscription multi-standby (MSMS) communication device” refers to any one or all of cellular telephones, smartphones, personal or mobile multi-media players, personal data assistants, laptop computers, tablet computers, smartbooks, palmtop computers, wireless electronic mail receivers, multimedia Internet enabled cellular telephones, wireless gaming controllers, and similar electronic devices and portable computing platforms that include a programmable processor, a memory, and a shared radio frequency (RF) resource, and are configured to support two or more subscriptions. Various examples may be particularly useful in any communication devices that can support multiple wireless wide area network subscriptions and receive cell broadcasts via the shared RF resource.

The terms “component,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on an MSMS communication device and the MSMS communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

To support multiple subscriptions, a multi-subscription multi-standby communication device may employ a tune-away procedure to monitor multiple interfaces using a single shared RF resource in which the shared RF resource is tuned to a first network (i.e., tuned to a carrier signal associated with the first network), subsequently tuned away to a second network for a short time (i.e., tuning to another carrier signal of the second network), and then is tuned back to the first network to continue a voice or data call. The tune-away procedure may allow the multi-subscription multi-standby communication device to monitor for pages or other indications of incoming messages or data received on the second network, to receive signals from other cells for cell selection or reselection, and to monitor signals other than bearer or control signals (e.g., master information blocks (MIBs) and system information blocks (SIBs)), from two or more communication networks.

Tuning away from the first network to the second network may interrupt communications with the first network, and may reduce the speed and efficiency with which the multi-subscription multi-standby communication device may conduct communication activities with the first network. During a process of cell selection or cell acquisition on the first network, performing tune-aways to the second network may frequently interrupt the cell selection activities and/or cell acquisition activities (referred to for conciseness as “cell acquisition activities” of a “cell acquisition procedure”) on the first network, causing substantial delay in completing the cell acquisition procedure, thus delaying the establishment of any pending high priority communication session, such as a voice communication session or an emergency call, on the first network.

For example, performing a cell acquisition procedure in a Global System for Mobility (GSM) Enhanced Data GSM Environment (EDGE) radio access network (RAN) (collectively, GERAN) may include performing a series of operations that may include, for example, performing a band scan to detect available frequencies/carrier bands, decoding a Broadcast Control Channel (BCCH) list, selecting a specific BCCH, and establishing communication with a cell of the communication network. Collectively, this series of operations may be substantially time-consuming. Furthermore, performing tune-aways to another network during the GERAN cell acquisition procedure may interrupt the various cell acquisition activities, further delaying their completion, and delaying the setup of any high priority communication session over GERAN.

A communication session or service may be considered high priority relative to another communication session on the multi subscription multi-standby communication device. For example, a voice communication session may be assigned a higher priority than a data communication session. Thus, the voice communication session initiated or attempted on the first subscription may be given a higher priority than a data communication session established or being conducted on the second subscription. In general, a voice service may be prioritized over a data service. As another example, a voice communication session initiated over the first subscription may be assigned a higher priority than any non-voice communication activity on the second subscription. Non-voice communication activity may include cell selection activities, data communication, background data traffic, cell signal measurements, frequency band scanning, and other non-voice communications.

Various examples provide methods implemented by a processor in a multi-subscription multi-standby communication device that may manage an RF resource in a multi-subscription multi-standby communication device for cell acquisition. A cell acquisition procedure may include one or more steps performed by the multi-subscription multi-standby communication device to select or acquire a cell of a communication network (i.e., to establish communication with a network element, such as a cell or a base station, of the communication network) to enable the multi-subscription multi-standby communication device to establish and conduct a communication session over the communication network.

In various examples, the MSMS communication device may receive, at a radio resource management sublayer associated with a first radio access technology (referred to as a “first radio resource management sublayer”), a request to establish communication session over a first subscription communication network using a first subscription (e.g., over a communication network associated with the first subscription). The MSMS communication device may initialize a guard timer for a time period (referred to herein as a “guard time period”). Until the guard time period has elapsed (e.g., during the guard time period), the MSMS communication device may block access to the RF resource by a second subscription of the MSMS communication device. Blocking the second subscription's access to the RF resource may prevent the second subscription from interrupting communication activities of the first subscription. The MSMS communication device may perform the cell acquisition procedure (i.e., various activities/operations associated with cell acquisition) on the first subscription during the guard time period.

In some examples, the first radio resource management sublayer associated with the first subscription may receive the request to establish the communication session from a second radio resource management sublayer associated with a second radio access technology. The second radio resource management sublayer associated with the second radio access technology may send the request when the second radio resource management sublayer receives a rejection message of a call request sent by the second radio resource management sublayer. In some examples, the first radio resource management sublayer associated with the first subscription may receive the request to establish the communication session from a non-access stratum of the MSMS communication device. The non-access stratum may indicate to the first radio resource management sublayer associated with the first subscription that the requested communication session is an emergency communication session or is a voice communication session.

In some examples, the MSMS communication device may determine whether the cell acquisition procedure on the first subscription has been completed. In some examples, the MSMS communication device may also determine whether a high priority communication session or service has been established over the first communication network. In such examples, the MSMS communication device may detect when the high priority communication session or service has ended, and may then permit the second subscription to access the RF resource. In some examples, the MSMS communication device may determine whether the cell acquisition procedure on the first subscription has been unsuccessful, and the MSMS communication device may permit access to the RF resource by the second subscription in response to determining that the cell acquisition procedure on the first subscription has failed. In some examples, the MSMS communication device may determine whether the guard time period has elapsed and permit access to the RF resource by the second subscription in response to determining that the guard time period has elapsed.

References to “first network,” “first subscription,” “second network” and “second subscription” herein are arbitrary and are used to refer to two or more subscriptions/networks generally because at any given time either subscription/network may be in an active mode (on an active voice or data call) or a standby mode, and all subscriptions/networks may need to monitor for system information (e.g., for network SIB transmissions). Also, references to “first” and “second” subscriptions and networks are not intended to imply that the claims are limited to two subscriptions sharing one RF resource, because three or more subscriptions may share one RF resource provided that only one subscription can use the RF resource at a time. Third and fourth subscriptions would behave similar to a second subscription. Therefore, in the interest of brevity, operations of subscriptions in the standby mode that share the RF resource during tune-away periods are described generally with reference to the “second” subscription.

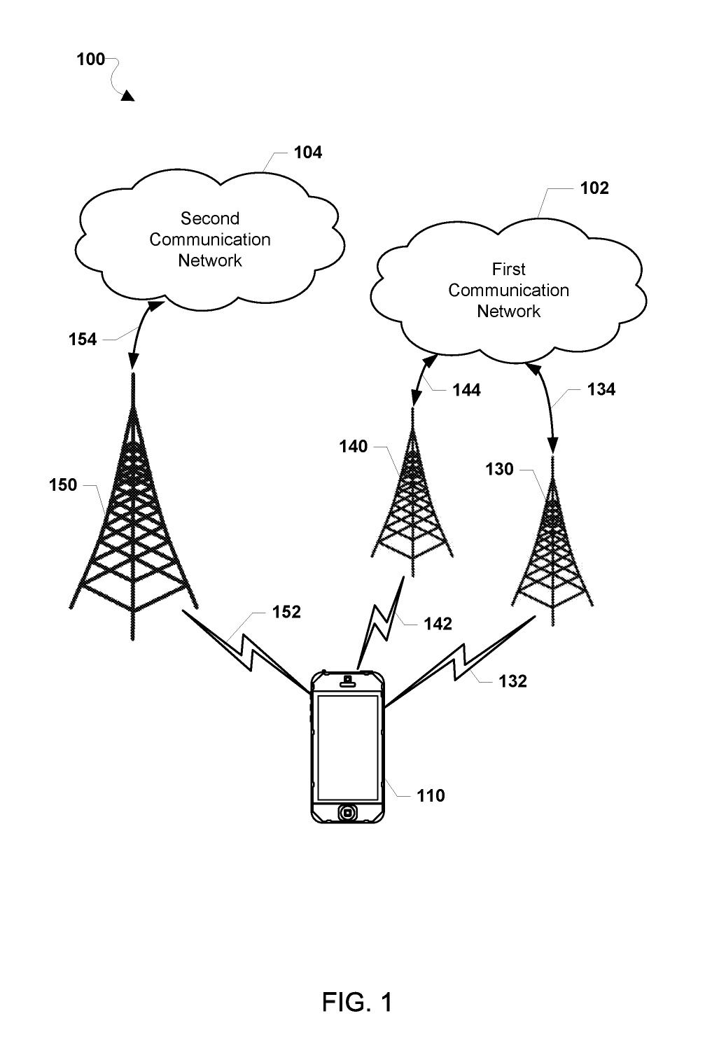

Various examples may be implemented within a variety of communication systems 100, such as systems that include at least two communication networks, an example of which is illustrated in FIG. 1. A first communication network 102 and a second communication network 104 each may include a plurality of base stations (e.g., a first base station 130, a second base station 140, and a third base station 150). A multi-subscription multi-standby communication device 110 may communicate with the first communication network 102 through a communication link 132 to the first base station 130 and through a communication link 142 to the second base station 140. The MSMS communication device 110 may also communicate with the second communication network 104 through a communication link 152 to the third base station 150. The first base station 130 may communicate with the first communication network 102 over a wired or wireless communication link 134, the second base station 140 may communicate with the first communication network 102 over a wired or wireless communication link 144, and the third base station 150 may communicate with the second communication network 104 over a wired or wireless communication link 154. The communication links 134, 144, 154 may include fiber optic backhaul links, microwave backhaul links, and other similar communication links.

Each of the communication networks 102 and 104 may support communications using one or more radio access technologies, and each of the communication links 132, 134, 142, 144, 152, and 154 may include cellular connections that may be made through two-way wireless communication links using one or more radio access technologies (RATs). Examples of RATs may include 3GPP Long Term Evolution (LTE), Worldwide Interoperability for Microwave Access (WiMAX), Code Division Multiple Access (CDMA), Time Division Multiple Access (TDMA), Wideband CDMA (WCDMA), Global System for Mobility (GSM), and other RATs. While the communication links 132, 134, 142, 144, 152, and 154 are illustrated as single links, each of the communication links may include a plurality of frequencies or frequency bands, each of which may include a plurality of logical channels. Additionally, each of the communication links 132, 134, 142, 144, 152, and 154 may utilize more than one RAT.

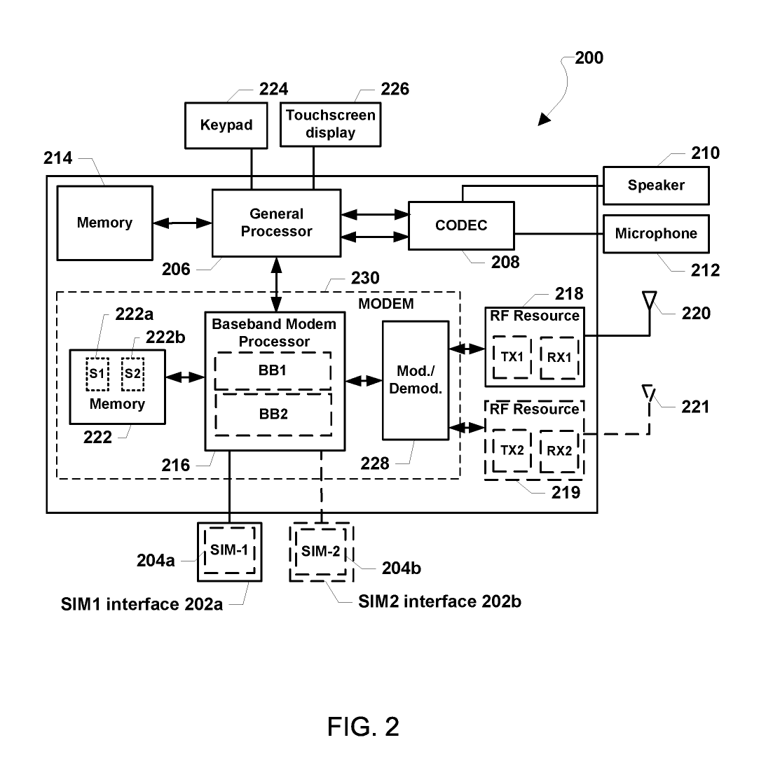

FIG. 2 is a component block diagram of a multi-subscription multi-standby communication device 200 suitable for implementing various examples. With reference to FIGS. 1 and 2, in various examples, the multi-subscription multi-standby communication device 200 may be similar to the multi-subscription multi-standby communication device 110. The multi-subscription multi-standby communication device 200 may include a first SIM interface 202a, which may receive a first identity module SIM-1 204a that may be associated with a first subscription. The multi-subscription multi-standby communication device 200 may optionally also include a second SIM interface 202b, which may receive a second identity module SIM-2 204b that may be associated with a second subscription.

A SIM in various examples may be a Universal Integrated Circuit Card (UICC) that is configured with SIM and/or USIM (Universal Subscriber Identity Module) applications, enabling access to, for example, GSM and/or Universal Mobile Telecommunications System (UMTS) networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM and I/O circuits. A SIM used in various examples may contain user account information, an international mobile subscriber identity (IMSI), a set of SIM application toolkit (SAT) commands and storage space for phone book contacts. A SIM card may further store a Home-Public-Land-Mobile-Network (HPLMN) code to indicate the SIM card network operator provider. An Integrated Circuit Card Identity (ICCID) SIM serial number may be printed on the SIM card for identification.

The multi-subscription multi-standby communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The memory 214 may be a non-transitory computer-readable storage medium that stores processor-executable instructions. The memory 214 may store an operating system (OS), as well as user application software and executable instructions. The memory 214 may also store application data, such as an array data structure.

The general-purpose processor 206 may be coupled to a modem 230. The modem 230 may include at least one baseband modem processor 216, which may be coupled to a memory 222 and a modulator/demodulator 228. The baseband modem processor 216 may include physically or logically separate baseband modem processors (e.g., BB1, BB2). The modulator/demodulator 228 may receive data from the baseband modem processor 216 and may modulate a carrier signal with encoded data and provide the modulated signal to the RF resource 218 for transmission. The modulator/demodulator 228 may also extract an information-bearing signal from a modulated carrier wave received from the RF resource 218, and may provide the demodulated signal to the baseband modem processor 216. The modulator/demodulator 228 may be or include a digital signal processor (DSP).

In some optional examples, the multi-subscription multi-standby communication device 200 may include an optional RF resource 219 configured similarly to the RF resource 218 and coupled to an optional wireless antenna 221. In such examples, the multi-subscription multi-standby communication device 200 may leverage the multiple RF resources 218, 219 and antennae 220, 221 to perform diversity receiver reception during a tune-away.

The baseband modem processor 216 may read and write information to and from the memory 222. The memory 222 may also store instructions associated with a protocol stack, such as protocol stack S1 222a and protocol stack S2 222b. The protocol stacks S1 222a, S2 222b generally include computer executable instructions to enable communication using a radio access protocol or communication protocol. Each protocol stack S1 222a, S2 222b typically includes network protocol layers structured hierarchically to provide networking capabilities. The modem 230 may include one or more of the protocol stacks S1 222a, S2 222b to enable communication using one or more RATs. The protocol stacks S1 222a, S2 222b may be associated with a SIM card (e.g., SIM-1 204a, SIM-2 204b) configured with a subscription. For example, the protocol stack S1 222a and the protocol stack S2 222b may be associated with the SIM-1 204a. The illustration of only two protocol stacks S1 222a, S2 222b is not intended as a limitation, and the memory 222 may store more than two protocol stacks (not illustrated).

Each SIM and/or RAT in the multi-subscription multi-standby communication device 200 (e.g., SIM-1 204a, SIM-2 204b) may be coupled to the modem 230 and may be associated with or permitted to use an RF resource. The term “RF resource” may be used to refer to all of the circuitry used to send and/or receive RF signals, which may include the baseband modem processor 216 that performs baseband/modem functions for communicating with/controlling a RAT, one or more radio units including transmitter and receiver components that are shown as RF resource 218, and optional RF resource 219, one or more of the wireless antenna 220 and the optional wireless antenna 221, and additional circuitry that may include one or more amplifiers and radios. In some examples, an RF resource may share a common baseband modem processor 216 (i.e., a single device that performs baseband/modem functions for all RATs on the multi-subscription multi-standby communication device). In some examples, each RF resource may include the physically or logically separate baseband processors (e.g., BB1, BB2).

The RF resources 218, 219 may include transceivers associated with one or more RATs and may perform transmit/receive functions for the multi-subscription multi-standby communication device 200 on behalf of their respective RATs. The RF resources 218, 219 may include separate transmit and receive circuitry. In some examples, an RF resource 218 may include only receive circuitry. The RF resources 218, 219 may each be coupled to a wireless antenna (e.g., the first wireless antenna 220 and the second wireless antenna 221). The RF resources 218, 219 may also be coupled to the modem 230 (e.g., via the modulator/demodulator 228, the baseband modem processor 216, or another component).

In some examples, the general-purpose processor 206, memory 214, baseband processor(s) 216, and the RF resources 218, 219 may be included in the multi-subscription multi-standby communication device 200 as a system-on-chip. In some examples, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the multi-subscription multi-standby communication device 200 may include, but are not limited to, a keypad 224 and a touchscreen display 226.

In some examples, the keypad 224, the touchscreen display 226, the microphone 212, or a combination thereof may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software components and functions in the multi-subscription multi-standby communication device 200 to enable communication between them.

Functioning together, the two SIMs 204a, 204b, the baseband processor(s) 216, RF resources 218, 219, and the antennas 220, 221 may enable communications on two or more RATs. For example, one SIM, baseband processor, and RF resource may be configured to support two different RATs. In some examples, more RATs may be supported on the multi-subscription multi-standby communication device 200 by adding more SIM cards, SIM interfaces, RF resources, and antennas for connecting to additional mobile networks.

The multi-subscription multi-standby communication device 200 may optionally include a tune-away management unit configured to manage the respective access of subscriptions associated with the first and second SIMs 204a, 204b to the RF resource 218 (and optionally the RF resource 219) in anticipation of or during a tune-away. In some examples, the tune-away management unit may determine whether to permit or to prevent access to the RF resource 281 (and optionally the RF resource 219), which may permit or prevent the performance of a tune-away. In some examples, the tune-away management unit may be implemented within the general-purpose processor 206. In other examples, the tune-away management unit may be implemented as a separate hardware component (i.e., separate from the general-purpose processor 206). In some examples, the tune-away management unit may be implemented as a software application stored within the memory 214 and executed by the general-purpose processor 206.

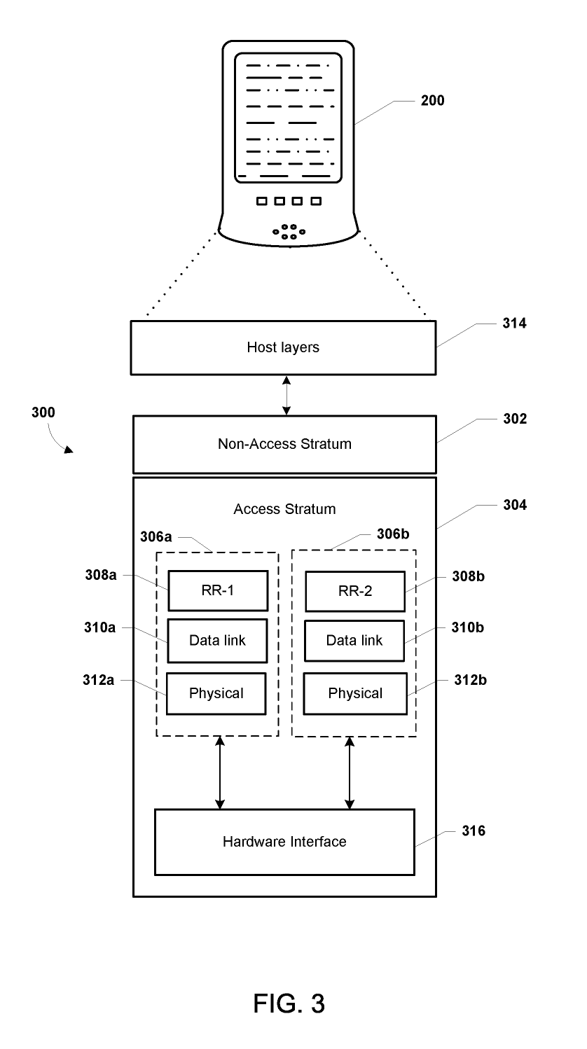

FIG. 3 illustrates an example of software architecture with layered radio protocol stacks that may be used in data communications on a MSMS communication device.

Referring to FIGS. 1-3, the wireless communication device 200 may have a layered software architecture 300 to communicate over access networks associated with SIMs. The software architecture 300 may be distributed among one or more processors, such as baseband-modem processor 216. The software architecture 300 may also include a Non-Access Stratum (NAS) 302 and an Access Stratum (AS) 304. The NAS 302 may include functions and protocols to support traffic and signaling each SIM of the wireless communication device 200 (e.g., the SIM-1 204a, and the SIM-2 204b) and their respective communication networks. The AS 304 may include functions and protocols that support communication between each SIM and network entities of their respective access networks (e.g., a Mobile Switching Center (MSC) in a GSM network, and eNodeB in an LTE network, or another similar network element).

In the wireless communication device 200, the AS 304 may include multiple protocol stacks, each of which may be associated with a different SIM. For example, the AS 304 may include protocol stacks 306a, 306b, associated with the SIM-1 204a and the SIM-2 204b, respectively. Although described below with reference to GSM-type communication layers, protocol stacks 306a, 306b may support any of variety of standards and protocols for wireless communications. In particular, the AS 304 may include at least three layers, each of which may contain various sublayers. For example, each protocol stack 306a, 306b may respectively include a Radio Resource (RR) management sublayer (e.g., RR-1 308a, RR-2 308b) as part of Layer 3 (L3) of the AS 304 in a GSM or another radio access protocol. The radio resource management sublayers 308a, 308b may oversee the establishment of a communication link between the wireless communication device 200 and an associated communication network. In the various examples, the NAS 302 and radio resource management sublayers 308a, 308b may perform various functions to search for communication networks and to establish, maintain and terminate communication sessions over the communication networks. Further, the radio resource management sublayers 308a, 308b may provide functions including broadcasting system information, paging, and establishing and releasing a radio resource control (RRC) signaling connection between a multi-SIM wireless communication device 200 and the associated access network. While not shown, the software architecture 300 may include additional Layer 3 sublayers, as well as various upper layers above Layer 3.

Additional sub-layers may include, for example, connection management (CM) sub-layers (not shown) that route calls, select a service type, prioritize data, perform QoS functions, etc.

Residing below the Layer 3 sublayers (RR management sublayers 308a, 308b), the protocol stacks 306a, 306b may also include data link layers 310a, 310b, which may be part of Layer 2 in a GSM or another radio access technology protocol. The data link layers 310a, 310b may provide functions to handle incoming and outgoing data across the network, such as dividing output data into data frames and analyzing incoming data to ensure the data has been successfully received In some examples, each data link layer 310a, 310b may contain various sublayers, such as a media access control (MAC) sublayer, a radio link control (RLC) sublayer, and a packet data convergence protocol (PDCP) sublayer, each of which form logical connections terminating at the access network. In various examples, a PDCP sublayer may provide uplink functions including multiplexing between different radio bearers and logical channels, sequence number addition, handover data handling, integrity protection, ciphering, and header compression. In the downlink, the PDCP sublayer may provide functions that include in-sequence delivery of data packets, duplicate data packet detection, integrity validation, deciphering, and header decompression.

In the uplink, the RLC sublayer may provide segmentation and concatenation of upper layer data packets, retransmission of lost data packets, and Automatic Repeat Request (ARQ). In the downlink, the RLC sublayer functions may include reordering of data packets to compensate for out-of-order reception, reassembly of upper layer data packets, and ARQ.

In the uplink, the MAC sublayer may provide functions including multiplexing between logical and transport channels, random access procedure, logical channel priority, and hybrid-ARQ (HARQ) operations. In the downlink, the MAC layer functions may include channel mapping within a cell, de-multiplexing, DRX, and HARQ operations.

Residing below the data link layers 310a, 310b, the protocol stacks 306a, 306b may also include physical layers 312a, 312b, which may establish connections over the air interface and manage network resources for the wireless communication device 200. In various examples, the physical layers 312a, 312b may oversee functions that enable transmission and/or reception over the air interface. Examples of such physical layer functions may include cyclic redundancy check (CRC) attachment, coding blocks, scrambling and descrambling, modulation and demodulation, signal measurements, MIMO, etc.

While the protocol stacks 306a, 306b provide functions to transmit data through physical media, the software architecture 300 may further include at least one host layer 314 to provide data transfer services to various applications in the wireless communication device 200.

In some examples, application-specific functions provided by the at least one host layer 314 may provide an interface between the protocol stacks 306a, 306b and the genera-purpose processor 206. In some examples, the protocol stacks 306a, 306b may each include one or more higher logical layers (e.g., transport, session, presentation, application, etc.) that provide host layer functions. For example, in some examples, the software architecture 300 may include a network layer (e.g., Internet Protocol (IP) layer) in which a logical connection terminates at a communication network gateway or other similar network element. In some examples, the software architecture 300 may include an application layer in which a logical connection terminates at another device (e.g., end user device, server, etc.). In some examples, the software architecture 300 may further include in the AS 304 a hardware interface 316 between the physical layers 312a, 312b and the communication hardware (e.g., one or more RF resource).

In various examples, the protocol stacks 306a, 306b of the layered software architecture may be implemented to allow modem operation using information provisioned on multiple SIMs. Therefore, a protocol stack that may be executed by a baseband-modem processor is interchangeably referred to herein as a modem stack.

The modem stacks in various examples may support any of a variety of current and/or future protocols for wireless communications. For examples, the modem stacks in various examples may support networks using radio access technologies described in 3GPP standards (e.g., GSM, UMTS, LTE, etc.), 3GPP2 standards (e.g., 1xRTT/CDMA2000, Evolved Data Optimized (EVDO), Ultra Mobile Broadband (UMB), etc.) and/or Institute of Electrical and Electronics Engineers (IEEE) standards (WiMAX, Wi-Fi, etc.).

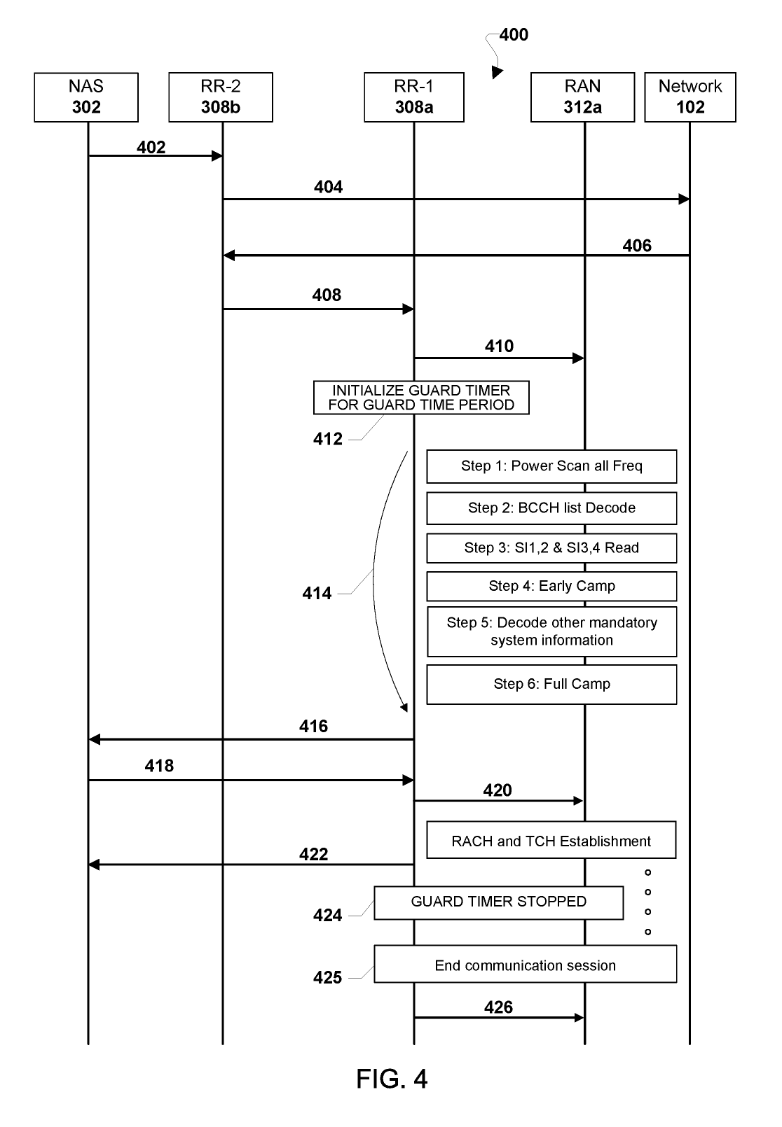

FIG. 4 illustrates a message flow diagram 400 for a method of managing an RF resource in a multi-subscription multi-standby communication device during cell acquisition according to some examples.

With reference to FIGS. 1-4, the operations involved in sending and receiving the messages illustrated in the message flow diagram 400 may be implemented by a multi-subscription multi-standby communication device (e.g., the multi-subscription multi-standby communication device 110, 200), such as under the control of a processor (e.g., the general-purpose processor 206, the baseband processor 216, a separate controller, and/or the like) executing operations of the method.

The non-access stratum (NAS) 302 may send to a second radio resource management sublayer associated with a second radio access technology (e.g., RR-2 308b) a request 402 (e.g., a call request) to establish a high priority communication session, such as a voice communication session. The communication session may be considered a high priority communication session relative to a non-voice communication session e.g., on the second subscription), a data service or communication session, or other activities such as cell selection activities, daily communication, background data traffic, sell signal measurements, frequency band scanning, and the like. The second radio resource management sublayer associated with the second radio access technology may send a request 404 to the communication network 102 to establish the high priority communication session. The request 402 may thus be a request to establish the communication session using the second radio access technology.

The radio resource management sublayer RR-2 308b may send an RRC_Connection_Request message 404 to the communication network 102 may reject the communication session request for a variety of reasons, such as due to network congestion. The communication network 102 may send a rejection 406 to the radio resource management sublayer 308b. The rejection 406 may include, for example, an RRC_Connection_Reject message. In some examples, the rejection 406 may include a message (e.g., a redirection message) instructing or advising the multi-subscription multi-standby communication device via the radio resource management sublayer RR-2 308b to attempt to establish the communication session using a different radio access technology, such as a first radio access technology. The radio resource management sublayer RR-2 308b may then send a message 408 (e.g., a redirect request) to a radio resource management sublayer (e.g., RR-1) 308a associated with the first radio access technology to attempt to establish the communication session.

The radio resource management sublayer RR-1 308a may send to a physical layer component (e.g. RAN) 312a a message 410 instructing the physical layer component 312a to block access to the RF resource of the multi-subscription multi-standby communication device. (An example of the RAN 312a includes a GERAN Layer 1 component.) The radio resource management sublayer RR-1 308a may also initialize 412 a guard timer for a guard time period. In some examples, the radio resource management sublayer 308a may select the guard time period to provide sufficient time for the physical layer component 312a to perform operations of a cell acquisition procedure. The operations of the cell acquisition procedure may be relatively time-consuming, and in some examples the selected guard time period may be approximately 10 seconds. During the period of the guard timer, the physical layer component 312a may block access to the RF resource by the second subscription of the MSMS communication device.

The physical layer component 312a may also perform 414 one or more operations of the cell acquisition procedure. Such operations may include performing a scan of available frequencies that use the first radio access technology, decoding a list of a Broadcast Control Channels (BCCHs) received by the multi-subscription multi-standby communication device, reading system information (e.g., system information blocks SI 1, 2, SI 3, 4, etc.) received by the multi-subscription multi-standby communication device, performing an initial selection (e.g., “early camp”) of a cell that uses the first radio access technology, decoding other mandatory system information received by the multi-subscription multi-standby communication device (e.g., system information used to establish a communication link with a cell/base station), and performing a final selection (e.g., “full camp”) of a cell that uses the first radio access technology. As the physical layer component 312a performs the operations of the cell acquisition procedure during the guard time period, the physical layer component 312a may block access to the RF resource by second subscription of the multi-subscription multi-standby communication device during performance of the cell acquisition activities (e.g., during the guard time period).

Following completion of the cell acquisition procedure, the RR-1 308a (associated with the first radio access technology) may send a message 416 to the NAS 302 indicating that the communication link with the first communication network has been established. The NAS 302 may send a message 418 to the RR-1 308a requesting the establishment of the communication session (e.g., a voice communication session, such as a mobile-originated circuit-switched communication session).

The RR-1 308a may send a message 420 to the physical layer component 312a instructing the physical layer component 312a to establish the communication session over the first communication network. The physical layer component 312a may then establish the communication session with the first communication session (e.g., by performing a Random Access Channel (RACH) procedure to establish a traffic channel (TCH) over which to conduct the communication session on the first communication network). Upon establishment of the TCH, the radio resource management sublayer 308a may send a message 422 to the NAS 302 indicating that the TCH has been established. Following the establishment of the TCH, the multi-subscription multi-standby communication device may conduct the voice communication session. After the establishment of the TCH, the guard timer may be stopped 424.

Following the end of the communication session 425, the radio resource management sublayer RR-1 308a may send to the physical layer component 312a a message 426 indicating that the physical layer component 312a may permit access to the RF resource by the second subscription. Additionally or alternatively, the radio resource management sublayer 308a may determine that the physical layer component 312a has completed the one or more operations of the cell acquisition procedure 414, and may send the message 426 before the guard timer elapses.

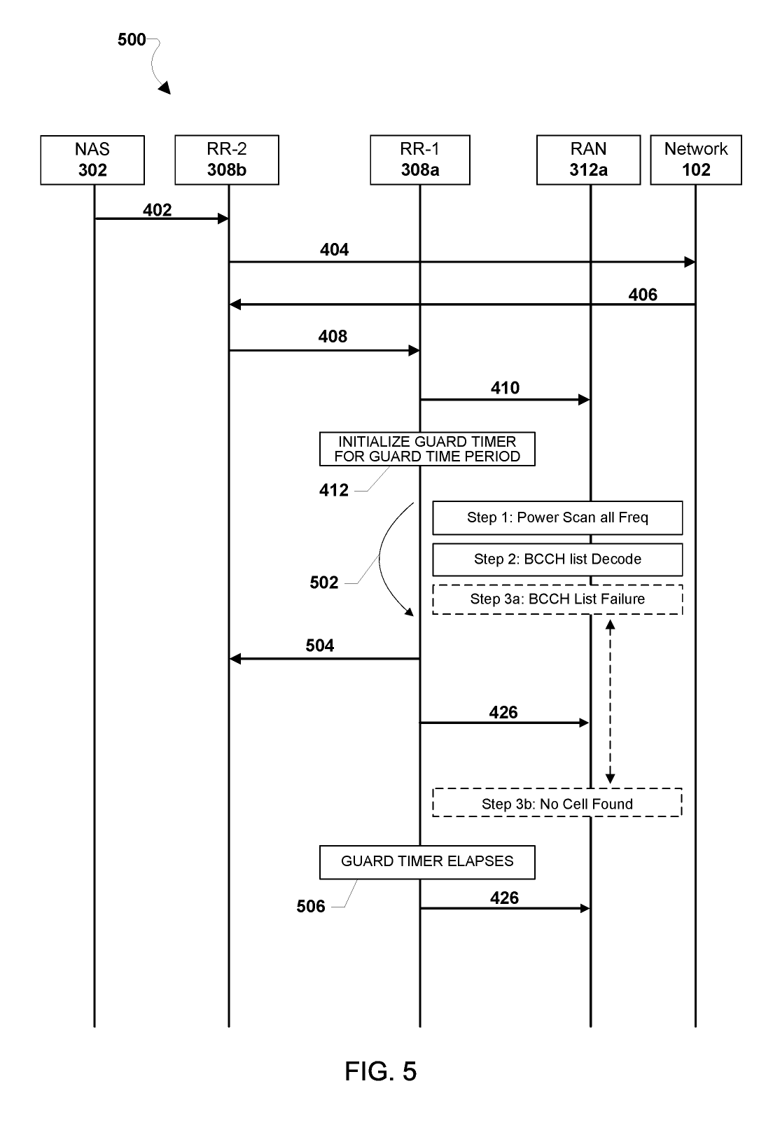

FIG. 5 illustrates a message flow diagram 500 of a method of managing an RF resource in a multi-subscription multi-standby communication device during cell acquisition according to some examples.

With reference to FIGS. 1-5, the operations involved in sending and receiving the messages illustrated in the message flow diagram 500 may be implemented by a multi-subscription multi-standby communication device (e.g., the multi-subscription multi-standby communication device 110, 200), such as under the control of a processor (e.g., the general-purpose processor 206, the baseband processor 216, a separate controller, and/or the like) executing operations of the method. The device processor may perform operations related to messages 402-412 and 426 of like-numbered operations of the message flow diagram 400 as described.

The physical layer component 312a may also perform one or more operations 502 of the cell acquisition procedure. However, the cell acquisition procedure may be unsuccessful, and the multi-subscription multi-standby communication device may detect a cell acquisition failure. In response to determining that the cell acquisition procedure has been unsuccessful, the RR-1 308a may send the message 426 to the physical layer component 312a indicating that the physical layer component 312a may permit access to the RF resource by the second subscription.

For example, in optional step 3a, physical layer component 312a may detect a BCCH list failure, such as a failure to decode system information that is used to establish communication with a neighboring cell. In response to detecting the BCCH list failure, the RR-1 308a may send a message 504 to the radio resource management sublayer RR-2 308b indicating the BCCH list failure (e.g., the failure to decode the system information). The radio resource management sublayer RR-1 308a may then send the message 426 to the physical layer component 312a.

As another example, in optional step 3b, the physical layer component 312a may not detect any neighbor cells and/or may not receive any neighbor cell system information before the guard timer elapses. The guard timer may elapse 506 before any neighbor cells are detected and/or any neighbor cell system information is decoded by the physical layer component 312a. The radio resource management sublayer RR-1 308a may then send the message 426 to the physical layer component 312a.

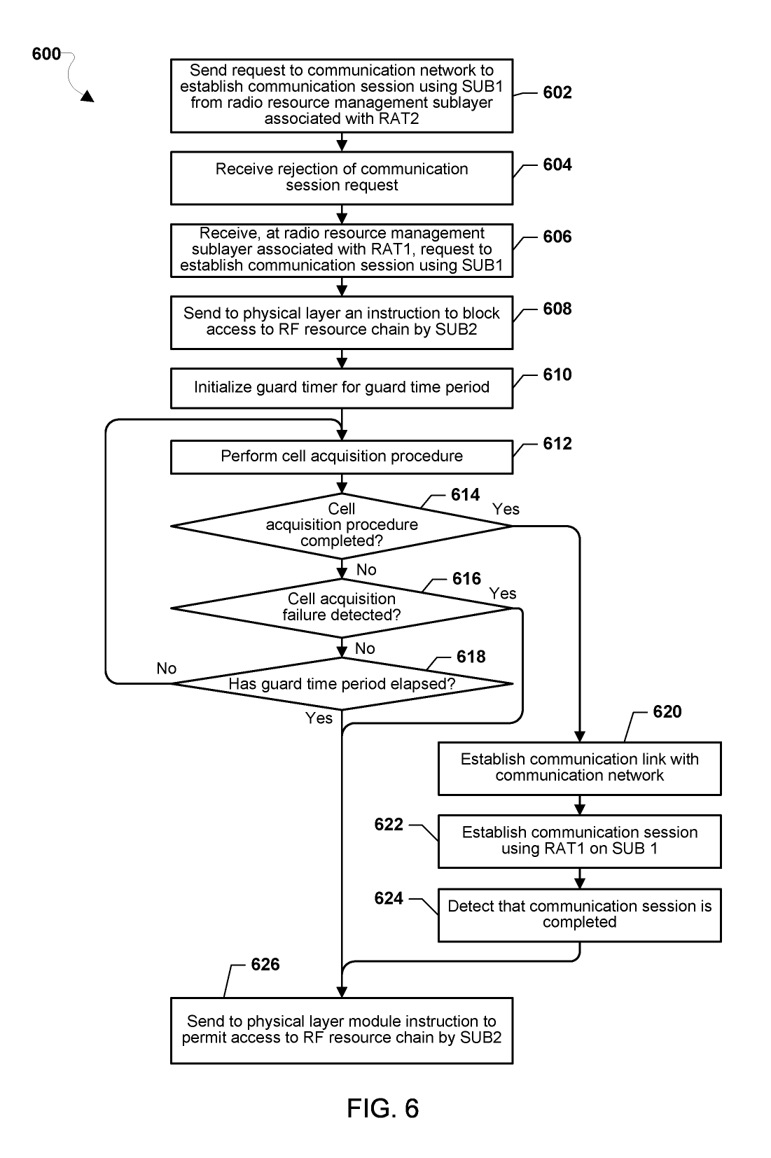

FIG. 6 illustrates a method 600 for a method for managing an RF resource in a multi-subscription multi-standby communication device during cell acquisition according to some examples. With reference to FIGS. 1-6, the method 600 may be implemented by a multi-subscription multi-standby communication device (e.g., the multi-subscription multi-standby communication device 110, 200), such as under the control of a processor (e.g., the general-purpose processor 206, the baseband processor 216, a separate controller, and/or the like) executing operations of the method.

In block 602, the device processor may send from a radio resource management sublayer (e.g., the RR-2 308b) associated with a second radio access technology (e.g., RAT2) to a communication network a request to establish a communication session using a first subscription (e.g., SUB1). The communication network may be associated with the first subscription (e.g., may be a first subscription communication network).

In block 604, the device processor may receive from the communication network a rejection of the communication session request. The rejection may indicate a reason for the rejection, for example, network congestion at the communication network.

In block 606, the device processor may receive, at a first radio resource (e.g., the radio resource management sublayer RR-1 308a) associated with a first radio access technology (e.g., RAT1), a request to establish the communication session using the first subscription. The first radio resource management sublayer associated with the first radio access technology may receive the request to establish the communication session from the second radio resource management sublayer associated with the second radio access technology.

In block 608, the device processor may send to the physical layer component an instruction to block access to an RF resource of the multi-subscription multi-standby communication device by the second subscription (e.g., SUB2).

In block 610, the device processor may initialize a guard timer for a guard time period. In some examples, the device processor may select the guard time period to provide sufficient time for the physical layer component to perform operations of a cell acquisition procedure. During the guard time period, the device processor may block access by the second subscription to the RF resource in order to prevent the interruption of a cell acquisition procedure by the performance of a tune-away to the second subscription.

In block 612, the device processor may begin the cell acquisition procedure. In determination block 614, the device processor may determine whether the cell acquisition procedure has been completed.

In response to determining that the cell acquisition procedure has not been completed (i.e., determination block 614=“No”), the device processor may determine whether cell acquisition failure has been detected in determination block 616. For example, the device processor may fail to decode system information that is used to establish communication with a neighboring cell. As another example, the device processor may not detect any neighbor cells, or the device processor may not receive any system information.

In response to determining that cell acquisition failure is detected (i.e., determination block 616=“Yes”), the device processor may send an instruction to the physical layer component to permit access by the second subscription to the RF resource in block 626.

In response to determining that cell acquisition failure is not detected (i.e., determination block 616=“No”), the device processor may determine whether the guard time period has elapsed in determination block 618. In response to determining that the guard time period has not elapsed (i.e., determination block 618=“No”), the device processor may continue to perform the cell acquisition procedure in block 612.

In response to determining that the guard time period has elapsed (i.e., determination block 618=“Yes”), the device processor may send an instruction to the physical layer component to permit access by the second subscription to the RF resource in block 626.

Returning to determination block 614, in response to determining that the cell acquisition procedure is completed (i.e., determination block 614=“Yes”), the device processor may establish a communication link with the communication network in block 620, and establish a communication session using the first radio access technology on the first subscription in block 622. With the communication link established, the device processor may conduct the communication session.

In block 624, the device processor may detect that the communication session is completed. For example, the device processor may detect that the multi-subscription multi-standby communication device has ended the communication session. The device processor may also receive a notification from the communication network that the communication session has ended. The device processor may then send an instruction to the physical layer component to permit access by the second subscription to the RF resource in block 626.

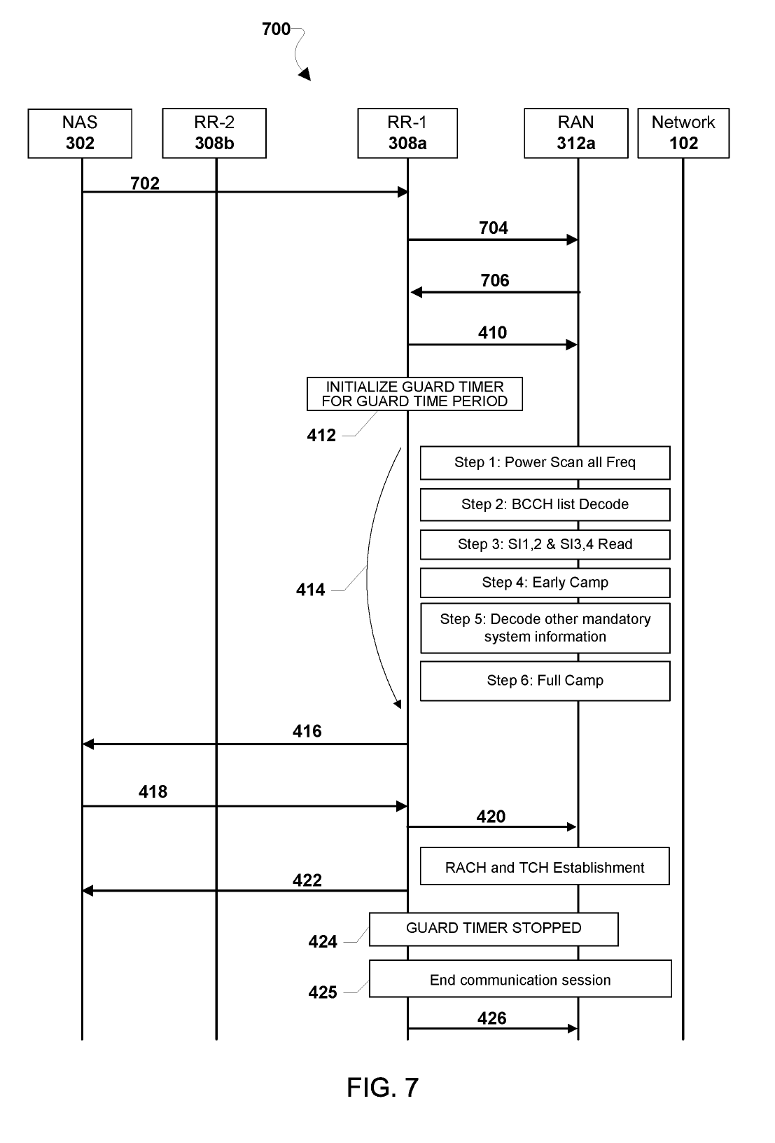

FIG. 7 illustrates a message flow diagram 700 for a method of managing an RF resource in a multi-subscription multi-standby communication device during cell acquisition according to some examples.

With reference to FIGS. 1-7, the operations involved in sending and receiving the messages illustrated in the message flow diagram 700 may be implemented by a multi-subscription multi-standby communication device (e.g., the multi-subscription multi-standby communication device 110, 200), such as under the control of a processor (e.g., the general-purpose processor 206, the baseband processor 216, a separate controller, and/or the like) executing operations of the method. The device processor may perform operations related to messages 410-426 of like-numbered operations of the message flow diagram 400 as described.

Under some circumstances, the NAS 302 may send a request 702 to establish a communication session to the RR-1 308a associated with the first radio access technology. The request 702 may also indicate that the requested communication session is a high-priority communication session, such as voice communication session or an emergency communication session. The NAS 302 may send the request 702 directly to the RR-1 308a further reduce delay in establishing communication with the first subscription network.

The radio resource management sublayer 308a may send a message 704 to the physical layer component 312a requesting that the physical layer attempt to establish the communication session. The physical layer component 312a may send a message 706 to the RR-1 308a confirming the request of the message 704. The RR-1 308a may then initialize 412 the guard timer for the guard time period, and may perform 414 one or more operations of the cell acquisition procedure.

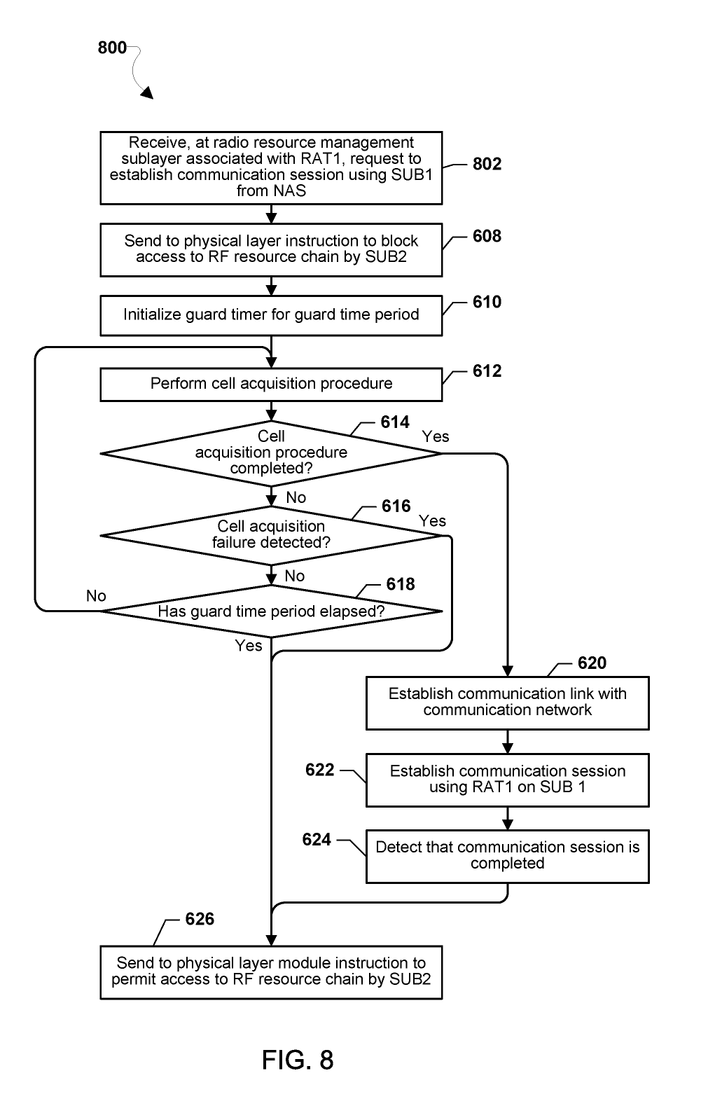

FIG. 8 illustrates a method 800 for a method for managing an RF resource in a multi-subscription multi-standby communication device during cell acquisition according to some examples. With reference to FIGS. 1-8, the method 800 may be implemented by a multi-subscription multi-standby communication device (e.g., the multi-subscription multi-standby communication device 110, 200), such as under the control of a processor (e.g., the general-purpose processor 206, the baseband processor 216, a separate controller, and/or the like) executing operations of the method. In blocks 608-626, the device processor may perform operations of like numbered blocks of the method 600.

In block 802, the device processor may receive (e.g., from the first radio resource management sublayer associated with a first radio access technology) a request to establish a communication session using the first subscription from a non-access stratum (e.g., the NAS 302) of the multi-subscription multi-standby communication device. For example, the non-access stratum may send a request to establish a communication session to the first radio resource management sublayer associated with the first radio access technology. Under certain circumstances, the non-access stratum may send the request to establish a communication session directly to the first radio resource management sublayer associated with the first radio access technology based on the nature of the requested communication session. For example, the requested communication session may be an emergency communication session, or may be time sensitive communication session, such as a voice communication session. In such cases, the non-access stratum may send the request to establish communication session directly to the first radio resource management sublayer associated with the first radio access technology.

In block 608, the device processor may send to the physical layer and instruction to block access to the RF resource by the second subscription.

Thus, the multi-subscription multi-standby communication device may be configured to manage an RF resource that is shared by two (or more) subscriptions to prevent interruption of a cell acquisition procedure performed by the multi-subscription multi-standby communication device using a first radio access technology by blocking access by the second subscription to the RF resource. Preventing interruption of the cell acquisition procedure may mitigate delays in completing the cell acquisition procedure caused by such interruptions, and may further mitigate delays in establishing a pending communication session.

Various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example. For example, one or more of the operations of the message flow diagrams 400, 500, and 700 and the methods 600 and 800 may be substituted for or combined with one or more operations of the message flow diagrams 400, 500, and 700 and the methods 600 and 800.

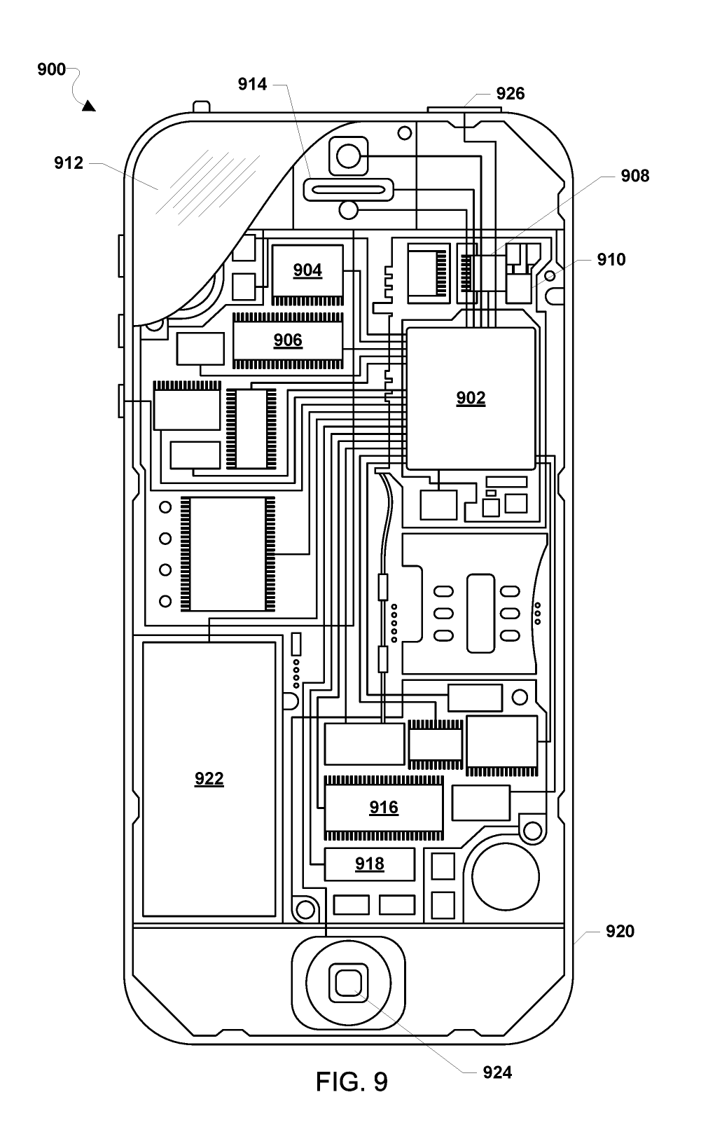

Various examples (including, but not limited to, examples described with reference to FIGS. 1-8) may be implemented in any of a variety of mobile communication devices, an example of which (e.g., mobile communication device 900) is illustrated in FIG. 9. With reference to FIGS. 1-9, in various examples, the multi-subscription multi-standby communication device 900 (which may correspond, for example, to the multi-subscription multi-standby communication devices 110 and 200) may include a processor 902 coupled to a touchscreen controller 904 and an internal memory 906. The processor 902 may be one or more multi-core integrated circuits designated for general or specific processing tasks. The internal memory 906 may be volatile or non-volatile memory, and may also be secure and/or encrypted memory, or unsecure and/or unencrypted memory, or any combination thereof. The touchscreen controller 904 and the processor 902 may also be coupled to a touchscreen panel 912, such as a resistive-sensing touchscreen, capacitive-sensing touchscreen, infrared sensing touchscreen, etc. Additionally, the display of the mobile communication device 900 need not have touch screen capability.

The mobile communication device 900 may have two or more radio signal transceivers 908 (e.g., Peanut, Bluetooth, ZigBee, Wi-Fi, RF radio) and antennae 910, for sending and receiving communications, coupled to each other and/or to the processor 902. The transceivers 908 and antennae 910 may be used with the above-mentioned circuitry to implement the various wireless transmission protocol stacks and interfaces. The mobile communication device 900 may include one or more cellular network wireless modem chip(s) 916 coupled to the processor and antennae 910 that enables communication via two or more cellular networks via two or more radio access technologies.

The mobile communication device 900 may include a peripheral device connection interface 918 coupled to the processor 902. The peripheral device connection interface 918 may be singularly configured to accept one type of connection, or may be configured to accept various types of physical and communication connections, common or proprietary, such as USB, FireWire, Thunderbolt, or PCIe. The peripheral device connection interface 918 may also be coupled to a similarly configured peripheral device connection port (not shown).

The mobile communication device 900 may also include speakers 914 for providing audio outputs. The mobile communication device 900 may also include a housing 920, constructed of a plastic, metal, or a combination of materials, for containing all or some of the components discussed herein. The mobile communication device 900 may include a power source 922 coupled to the processor 902, such as a disposable or rechargeable battery. The rechargeable battery may also be coupled to the peripheral device connection port to receive a charging current from a source external to the mobile communication device 900. The mobile communication device 900 may also include a physical button 924 for receiving user inputs. The mobile communication device 900 may also include a power button 926 for turning the mobile communication device 900 on and off.

The processor 902 may be any programmable microprocessor, microcomputer or multiple processor chip or chips that can be configured by software instructions (applications) to perform a variety of functions, including the functions of various examples described herein. In some mobile communication devices, multiple processors 902 may be provided, such as one processor dedicated to wireless communication functions and one processor dedicated to running other applications. Typically, software applications may be stored in the internal memory 906 before they are accessed and loaded into the processor 902. The processor 902 may include internal memory sufficient to store the application software instructions.

Various examples may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various examples must be performed in the order presented. As will be appreciated by one of skill in the art the order of blocks in the foregoing examples may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, components, circuits, and algorithm blocks described in connection with the examples disclosed herein may be implemented as electronic hardware, computer software, or combinations of both. To clearly illustrate this interchangeability of hardware and software, various illustrative components, blocks, components, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various examples.

The hardware used to implement the various illustrative logics, logical blocks, components, and circuits described in connection with the examples disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various examples, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software component, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed examples is provided to enable any person skilled in the art to make or use the present examples. Various modifications to these examples will be readily apparent to those skilled in the art, and the generic principles defined herein may be applied to other implementations without departing from the scope of the claims. Thus, the various claims are not intended to be limited to the examples shown herein but are to be accorded the widest scope consistent with the following claims and the principles and novel features disclosed herein.

What is claimed is:

1. A method for managing a radio frequency (RF) resource in a multi-subscription multi-standby (MSMS) communication device, comprising:
receiving, at a first radio resource management sublayer associated with a first radio access technology, a request to establish a voice communication session over a communication network using a first subscription;
initializing a guard timer for a guard time period; and
blocking access to the RF resource by a second subscription of the MSMS communication device until the guard time period has elapsed.

2. The method of claim 1, wherein receiving at the first radio resource management sublayer associated with the first radio access technology the request to establish the voice communication session over the communication network comprises receiving the request to establish the voice communication session over the communication network from a second radio resource management sublayer associated with a second radio access technology.

3. The method of claim 2, further comprising:
receiving, at the second radio resource management sublayer associated with the second radio access technology, a communication session rejection message from the communication network.

4. The method of claim 1, wherein receiving, at the first radio resource management sublayer associated with the first radio access technology, the request to establish the voice communication session over the communication network comprises receiving the request to establish the voice communication session over the communication network from a non-access stratum of the MSMS communication device.

5. The method of claim 1, wherein the requested voice communication session over the communication network is assigned a relatively higher priority over a non-voice communication of the second subscription.

6. The method of claim 1, further comprising:
performing a cell acquisition procedure on the first subscription during the guard time period.

7. The method of claim 6, further comprising:
determining whether the cell acquisition procedure on the first subscription has been completed;
establishing the voice communication session over the communication network using the first subscription in response to determining that the cell acquisition procedure has been completed; and
permitting access to the RF resource by the second subscription.

8. The method of claim 6, further comprising:
determining whether the guard time period has elapsed; and
permitting access to the RF resource by the second subscription in response to determining that the guard time period has elapsed.

9. The method of claim 6, further comprising:
determining whether a cell acquisition failure is detected; and
permitting access to the RF resource by the second subscription in response to determining that the cell acquisition failure is detected.

10. The method of claim 9, further comprising:
continuing performance of the cell acquisition procedure in response to determining that the cell acquisition failure is not detected.

11. The method of claim 1, further comprising:
detecting that the voice communication session over the communication network is completed; and
permitting access to the RF resource by the second subscription.

12. A multi-subscription multi-standby (MSMS) communication device, comprising:
a radio frequency (RF) resource configured to support a first subscription and a second subscription; and
a processor coupled to the RF resource and configured with processor-executable instructions to:
receive via a first radio resource management sublayer associated with a first radio access technology a request to establish a voice communication session over a communication network using the first subscription;
initialize a guard timer for a guard time period; and
block access to the RF resource by the second subscription of the MSMS communication device until the guard time period has elapsed.

13. The MSMS communication device of claim 12, wherein the processor is further configured to receive the request to establish the voice communication session over the communication network from a second radio resource management sublayer associated with a second radio access technology.

14. The MSMS communication device of claim 13, wherein the processor is further configured to:
receive, at the second radio resource management sublayer associated with the second radio access technology, a communication session rejection message from the communication network.

15. The MSMS communication device of claim 12, wherein the processor is further configured to receive the request to establish the voice communication session over the communication network from a non-access stratum of the MSMS communication device.

16. The MSMS communication device of claim 12, wherein the requested voice communication session over the communication network is assigned a relatively higher priority over a non-voice communication of the second subscription.

17. The MSMS communication device of claim 12, wherein the processor is further configured to:
perform a cell acquisition procedure on the first subscription during the guard time period.

18. The MSMS communication device of claim 17, wherein the processor is further configured to:
determine whether the cell acquisition procedure on the first subscription has been completed;
establish the voice communication session over the communication network using the first subscription in response to determining that the cell acquisition procedure has been completed; and
permit access to the RF resource by the second subscription.

19. The MSMS communication device of claim 17, wherein the processor is further configured to:
determine whether the guard time period has elapsed; and
permit access to the RF resource by the second subscription in response to determining that the guard time period has elapsed.

20. The MSMS communication device of claim 17, wherein the processor is further configured to:
determine whether a cell acquisition failure is detected; and
permit access to the RF resource by the second subscription in response to determining that the cell acquisition failure is detected.

21. The MSMS communication device of claim 20, wherein the processor is further configured to:
continue performance of the cell acquisition procedure in response to determining that the cell acquisition failure is not detected.

22. The MSMS communication device of claim 12, wherein the processor is further configured to:
detect that the voice communication session over the communication network is completed; and
permit access to the RF resource by the second subscription.

23. A multi-subscription multi-standby (MSMS) communication device, comprising:
a radio frequency (RF) resource configured to support a first subscription and a second subscription; and
means for receiving, at a radio resource management sublayer associated with a first radio access technology, a request to establish a voice communication session over a communication network using the first subscription;
means for initializing a guard timer for a guard time period; and
means for blocking access to the RF resource by the second subscription of the MSMS communication device until the guard time period has elapsed.

24. A non-transitory processor readable storage medium having stored thereon processor-executable instructions configured to cause a processor of a multi-subscription multi-standby (MSMS) communication device comprising a radio frequency (RF) resource configured to support a first subscription and a second subscription to perform operations comprising:
receiving, at a first radio resource management sublayer associated with a first radio access technology, a request to establish a voice communication session over a communication network using the first subscription;
initializing a guard timer for a guard time period; and
blocking access to the RF resource by the second subscription of the MSMS communication device until the guard time period has elapsed.

25. The non-transitory processor readable storage medium of claim 24, wherein the stored processor-executable software instructions are configured to cause a processor to perform operations such that receiving at the first radio resource management sublayer associated with the first radio access technology the request to establish the voice communication session over the communication network comprises receiving the request to establish the voice communication session over the communication network from a second radio resource management sublayer associated with a second radio access technology.

26. The non-transitory processor readable storage medium of claim 25, wherein the stored processor-executable software instructions are configured to cause a processor to perform operations further comprising:
receiving, at the second radio resource management sublayer associated with the second radio access technology, a communication session rejection message from the communication network.

27. The non-transitory processor readable storage medium of claim 24, wherein the stored processor-executable software instructions are configured to cause a processor to perform operations such that receiving, at the first radio resource management sublayer associated with the first radio access technology, the request to establish the voice communication session over the communication network comprises receiving the request to establish the voice communication session over the communication network from a non-access stratum of the MSMS communication device.

28. The non-transitory processor readable storage medium of claim 24, wherein the stored processor-executable software instructions are configured to cause a processor to perform operations such that the requested voice communication session over the communication network is assigned a relatively higher priority over a non-voice communication of the second subscription.

29. The non-transitory processor readable storage medium of claim 24, wherein the stored processor-executable software instructions are configured to cause a processor to perform operations further comprising:
performing a cell acquisition procedure on the first subscription during the guard time period.

30. The non-transitory processor readable storage medium of claim 29, wherein the stored processor-executable software instructions are configured to cause a processor to perform operations further comprising:
determining whether the cell acquisition procedure on the first subscription has been completed;
establishing the voice communication session over the communication network using the first subscription in response to determining that the cell acquisition procedure has been completed; and
permitting access to the RF resource by the second subscription.
